(19) United States
(12) Patent Application Publication
(10) Pub. No.: US 2010/0095321 A1
(43) Pub. Date: Apr. 15, 2010

(54) Digital Broadcast Recording/Reproducing Apparatus and Parental Control Method for Digital Television Program

(75) Inventor: Hiroaki SHIBAHARA, Daito-shi (JP)

Correspondence Address: CROWELL & MORING LLP;INTELLECTUAL PROPERTY GROUP, P.O. BOX 14300, WASHINGTON, DC, 20044-4300, US

(73) Assignee: Funai Electric Co., Ltd., Daito-shi (JP)

(21) Appl. No.: 12/578,078

(22) Filed: Oct. 13, 2009

(30) Foreign Application Priority Data
Oct. 10, 2008 (JP) 2008-263666

(51) Int. Cl. H04N 7/16; H04N 7/173

(52) U.S. Cl. 725/28; 386/124; 386/E05.003

(57) ABSTRACT

This digital broadcast recording/reproducing apparatus includes a control portion performing parental control of a digital television program on the basis of rating information. The control portion is formed to recognize whether or not the rating information is updated from that at the time of recording of the digital television program when reproducing the recorded digital television program and to inquire of the user as to whether or not to perform parental control of the digital television program if the rating information is updated at the time of reproduction.

### BACKGROUND OF THE INVENTION

1. Field of the Invention

The present invention relates to a digital broadcast recording/reproducing apparatus and a parental control method for a digital television program, and more particularly, it relates to a digital broadcast recording/reproducing apparatus including a receiving portion receiving a digital television broadcast signal including rating information and a parental control method for a digital television program.

2. Description of the Background Art

A V-chip for cutting off a television program including violent or sexual expression unsuitable to young people or the like and performing parental control of the television program has been known in recent years. The V-chip must be loaded on a television set particularly in North America. In order to enable parental control with the V-chip, a broadcast signal includes a rating (program rating information), indicating the contents of a television program to be broadcast, used as the criterion for parental control. The V-chip previously stores rating information, so that the user sets parental control on the basis of the rating information. The V-chip refers to the rating (program rating information) of the television program and recognizes whether or not the same includes a rating set by the user for parental control, thereby performing parental control of (cutting off) the program. A recent broadcast signal includes updatable rating information (rating table), and a V-chip capable of changing the contents of the rating information (rating table) by rewriting the rating information to received updated rating information (rating table) in addition to rating information having been unrewritably stored in the V-chip.

In response to a digital television broadcast including the aforementioned rating information, a digital broadcast recording/reproducing apparatus including a receiving portion receiving a digital television broadcast signal including rating information is known in general, as disclosed in each of Japanese Patent Laying-Open Nos. 2008-141571, 2007-74372, 2001-268462 and 2000-184305, for example.

The aforementioned Japanese Patent Laying-Open No. 2008-141571 discloses a digital television broadcast receiver including a receiving portion receiving a digital broadcast signal, a control portion performing parental control of a digital television program including program rating information and a nonvolatile memory updatably storing rating information (rating table (RRT)) included in a digital television broadcast signal. The nonvolatile memory of the digital television broadcast receiver previously stores an unrewritable rating table (fixed RRT) in addition to an updatable rating table (variable RRT). The digital broadcast signal includes a digital television program including program rating information and a variable RRT. The nonvolatile memory is formed to store the updatable variable RRT in association with a broadcast station (channel) supplying the digital broadcast signal. The program rating information of the digital television program includes an identifier indicating on which RRT (fixed or variable RRT) the program rating information is based. The control portion is enabled to identify the program rating information based on the variable RRT by comparing the identifier included in each RRT with the identifier included in the program rating information. The control portion is formed to compare the identifier included in the program rating information of the digital television program with the identifier of the updatable variable RRT, to perform parental control based on the updatable variable RRT if the identifiers match with each other, and to perform parental control based on the fixed RRT if the identifiers do not match with each other.

The aforementioned Japanese Patent Laying-Open No. 2007-74372 discloses a television including a receiving portion receiving a broadcast signal, a control portion performing parental control of a broadcast program including program rating information and a memory previously storing rating information (RRT). The control portion of the television is formed to determine whether or not a prescribed rating of the RRT stored in the memory matches with the rating of the broadcast program and to display a black screen on a display of the television when determining that the ratings match with each other.

The aforementioned Japanese Patent Laying-Open No. 2001-268462 discloses a parental control system including a receiving portion receiving a television signal, a control portion performing parental control of a broadcast program including program rating information and a recordable medium for recording a received broadcast program. The control portion of this parental control system is formed to compare the rating of a program selected by the user or that of a recorded program to be reproduced by the user from the recordable medium with the rating of an object of parental control and to inhibit viewing or reproduction of the program if the rating of the program (channel) corresponds to that of the object of parental control.

The aforementioned Japanese Patent Laying-Open No. 2000-184305 discloses a television system including an input portion receiving program information including a program and a rating, a rating set portion setting the rating of an object of parental control, a rating determination portion comparing the rating of the program with the set rating of the object of parental control and a recording storage portion recording a program to be viewed. The rating set portion of this television system is enabled to set the rating (viewable rating) of a program to be viewed and recorded at the same time, in addition to a rating (inhibited rating) inhibiting viewing. The rating determination portion compares the rating of the program with a set rating of an object of parental control, and stores the program in the recording storage portion if the rating of the program matches with the viewable rating. When the rating of a selected program matches with the viewable rating, therefore, the program is recorded when the same is viewed, so that a caretaker or the like can confirm the contents of the program viewed by a child.

In the digital television broadcast receiver according to the aforementioned Japanese Patent Laying-Open No. 2008-141571, however, the variable RRT may be updated and the contents thereof may be changed before the recorded digital television program is reproduced if the program rating information is based on the variable RRT. When reproducing the recorded digital television program, the control portion performs parental control responsive to the program rating information of the recorded program on the basis of the updated variable RRT different from that at the time of recording. As a result, a program having been cut off in the setting based on the variable RRT at the time of recording may disadvantageously be reproduced without being cut off at the time of reproduction. Therefore, a program intended by the user to be cut off may be falsely reproduced when a recorded digital television program including program rating information is reproduced, due to the updating of the variable RRT (rating information).

In the television according to the aforementioned Japanese Patent Laying-Open No. 2007-74372, a variable RRT may be updated and the contents thereof may be changed before a recorded digital television program including program rating information is reproduced if parental control of a broadcast program including program rating information is performed on the basis of the variable RRT, although this document does not mention the variable RRT. In this case, the contents of a variable RRT stored in the memory are different from those of the variable RRT at the time of recording when the rating of the recorded program is set, and hence no rating corresponding to that of the recorded program may be present, or the contents of the same ratings may be different from each other. When the recorded digital television program including the program rating information is reproduced, therefore, a program intended by the user to be cut off may be falsely reproduced due to the updating of the variable RRT (rating information).

In the parental control system according to the aforementioned Japanese Patent Laying-Open No. 2001-268462, a variable RRT may be so updated that the contents of the variable RRT at the time of recording are different those of the variable RRT at the time of reproduction if parental control of the broadcast program including the program rating information is performed on the basis of the variable RRT, although this document does not mention the variable RRT. When the rating of the recorded program to be reproduced by the user from the recordable medium is compared with that of the object of parental control in this case, such an inconvenience may take place that the contents of the ratings are different from each other although the ratings match with each other, or the ratings are different from each other although the contents thereof are identical to each other. When the recorded digital television program including the program rating information is reproduced, therefore, a program intended by the user to be cut off may be falsely reproduced due to updating of the variable RRT (rating information).

In the television system according to the aforementioned Japanese Patent Laying-Open No. 2000-184305, a variable RRT of the rating set portion may be so updated that the contents of the variable RRT at the time of recording are different from those of the variable RRT at the time of reproduction if the rating of the program is based on the variable RRT, although this document does not mention the variable RRT. If a caretaker records a program corresponding to the inhibited rating and a child tries to reproduce the same, for example, the rating determination portion may conceivably determine that the rating of the program matches with the viewable rating when comparing the (unupdated) rating of the recorded program and the (updated) rating of the object of parental control as set. When the recorded digital program including the program rating information is reproduced, therefore, a program intended by the user to be cut off may be falsely reproduced due to the updating of the variable RRT (rating information).

### SUMMARY OF THE INVENTION

The present invention has been proposed in order to solve the aforementioned problems, and an object of the present invention is to provide a digital broadcast recording/reproducing apparatus capable of suppressing false reproduction of a program intended by the user to be cut off resulting from updating of rating information when reproducing a recorded digital television program.

A digital broadcast recording/reproducing apparatus according to a first aspect of the present invention includes a receiving portion receiving a digital television broadcast signal, supplied from a broadcast station, including rating information used as the criterion for parental control, a recording storage portion reproducibly storing the digital television broadcast signal received by the receiving portion and a control portion recording a prescribed digital television program included in the digital television broadcast signal received by the receiving portion in the recording storage portion, reproducing the recorded digital television program and performing parental control of the digital television program on the basis of the rating information, while the control portion is formed to recognize whether or not the rating information is updated from that at the time of recording of the digital television program when reproducing the digital television program recorded in the recording storage portion and to inquire of the user as to whether or not to perform parental control of the digital television program if the rating information is updated at the time of reproduction.

In the digital broadcast recording/reproducing apparatus according to the first aspect, as hereinabove described, the control portion is formed to recognize whether or not the rating information is updated from that at the time of recording of the digital television program when reproducing the digital television program recorded in the recording storage portion and to inquire of the user as to whether or not to perform parental control of the digital television program if the rating information is updated at the time of reproduction, whereby the control portion can recognize whether or not the rating information is updated when reproducing the recorded digital television program and can inquire of the user as to whether or not to perform parental control of the digital television program also when the rating information is updated. Thus, the user can reperform parental control of a program having a possibility of being cut off at the time of recording also after the contents of the rating information are changed due to updating, whereby false reproduction of a program intended by the user to be cut off can be suppressed.

In the aforementioned digital broadcast recording/reproducing apparatus according to the first aspect, the rating information preferably includes program rating information indicating the rating every digital television program and a rating table having a plurality of program rating information, the digital broadcast recording/reproducing apparatus preferably further includes a rating storage portion updatably storing the rating table, and the control portion is preferably formed to recognize whether or not the rating table is updated from that at the time of recording of the digital television program when reproducing the digital television program including the program rating information and to inquire of the user as to whether or not to perform parental control of the digital television program including the program rating information if the rating table is updated at the time of reproduction. According to this structure, the control portion can inquire of the user as to whether or not to perform parental control of the digital television program when reproducing the digital television program including the program rating information also when the rating table is updated between recording and reproduction of the digital television program including the program rating information and the contents of the rating table are changed.

In this case, the control portion is preferably formed to recognize whether or not the rating table is updated by comparing information related to updating of the rating table at the time of recording of the digital television program with information related to updating of the rating table at the time of reproduction of the digital television program. According to this structure, the control portion can easily recognize whether or not the rating table is updated by simply comparing the information related to updating of the rating table.

In the aforementioned structure related to the rating information including the rating table, the information related to updating of the rating table preferably includes at least either version information of the rating table or information related to the date of updating of the rating table. According to this structure, the control portion can easily recognize whether or not the rating table is updated with at least either the version information of the rating table or the information related to the date of updating of the rating table.

In this case, the control portion is preferably formed to recognize whether or not the rating table at the time of reproduction is updated by comparing version information of the rating table at the time of recording of the recorded digital television program with version information of the rating table at the time of reproduction. According to this structure, the control portion can easily recognize whether or not the rating table is updated between recording and reproduction of the digital television program.

In the aforementioned structure having the control portion comparing the version information of the rating table, the control portion is preferably formed to store at least the version information of the rating table at the time of recording when recording the digital television program. According to this structure, the control portion can easily compare the version information of the rating table at the time of recording with the version information of the rating table (rating information) at the present time (at the time of reproduction) stored in the rating storage portion.

In this case, the control portion is preferably formed to store the rating table at the time of recording including the version information when recording the digital television program. According to this structure, the control portion can acquire not only the version information of the rating table at the time of recording, but also the overall rating table.

In the aforementioned structure storing the rating table at the time of recording when recording the digital television program, the control portion is preferably formed to store the rating table at the time of recording including the version information in the recording storage portion along with the digital television program when recording the digital television program. According to this structure, the control portion may not add information associating the recorded digital television program with the rating table at the time of recording or the like to recorded data, but can store the digital television program and the rating table at the time of recording in the recording storage portion as such.

In the aforementioned structure related to the rating information including the rating table, the control portion is preferably formed to inform the user that the reproduced digital television program includes the program rating information and to confirm whether or not to reproduce the digital television program if the rating table at the time of reproduction is updated from the rating table at the time of recording when reproducing the digital television program including the program rating information. According to this structure, the user can determine whether or not to reproduce the recorded digital television program after recognizing that the reproduced digital television program includes the program rating information. Thus, the user can recognize the possibility that the reproduced digital television program is a program intended by him/her to be cut off and can determine whether or not to reproduce the same at his/her own discretion, whereby false reproduction of a program intended by the user to be cut off can be more reliably suppressed.

In this case, the control portion is preferably formed to inform the user that the reproduced digital television program includes the program rating information by displaying a message indicating that the reproduced digital television program includes the program rating information on a display. According to this structure, the user can visually recognize that the reproduced digital television program includes the program rating information through the message displayed on the display displaying images of the digital television program when reproducing the digital television program, whereby the control portion can reliably inform the user that the reproduced digital television program includes the program rating information dissimilarly to a case of informing the user that the reproduced digital television program includes the program rating information with a sound or the like.

In the aforementioned structure having the control portion informing the user that the reproduced digital television program includes the program rating information and confirming whether or not to reproduce the digital television program, the control portion is preferably formed to selectably display options as to whether or not to reproduce the digital television program on the display. According to this structure, the user can select whether or not to reproduce the digital television program from the options displayed on the display after recognizing the possibility that the reproduced digital television program is a program intended by him/her to be cut off without a complicated operation such as cancellation of parental control setting, for example.

In this case, the control portion is preferably formed to display at least the title of the recorded digital television program on the display in addition to the options when selectably displaying the options as to whether or not to reproduce the digital television program on the display. According to this structure, the user can grasp the contents of the program to some extent from the title or the like of the recorded digital television program when determining whether or not to reproduce the digital television program.

In the aforementioned structure related to the rating information including the rating table, the control portion is preferably formed to make an inquiry as to whether or not to perform parental control at the time of reproduction of the recorded digital television program including the program rating information when the rating table is updated every time the control portion reproduces the recorded digital television program including the program rating information. According to this structure, each user can reperform parental control of a program having a possibility of being cut off at the time of recording also when there are a plurality of users such as a caretaker and a child, for example, or no proper parental control has been set in precedent reproduction, whereby false reproduction of a program intended by the user to be cut off can be more reliably suppressed.

In the aforementioned structure related to the rating information including the rating table, the control portion is preferably formed to recognize whether or not the digital television program includes the program rating information when reproducing the digital television program recorded in the recording storage portion. According to this structure, the control portion can omit processing related to parental control with respect to a digital television program including no program rating information, for example.

In this case, the control portion is preferably formed to reproduce a digital television program not including the program rating information without recognizing whether or not the rating table is updated from that at the time of recording of the digital television program not including the program rating information if the recorded digital television program does not include the program rating information. According to this structure, the control portion reproduces the digital television program not including the program rating information and not requiring parental control without recognizing whether or not the rating table is updated and without inquiring of the user as to whether or not to perform parental control of the digital television program, whereby the control portion can perform only parental control of the digital television program including the program rating information without forcing the user to perform an unnecessary operation.

In the aforementioned structure including the rating storage portion updatably storing the rating table, the rating storage portion is preferably enabled to store an updatable variable rating table and an unupdatable fixed rating table, and the control portion is preferably formed to determine on which one of the variable rating table and the fixed rating table the program rating information of the reproduced digital television program is based when the reproduced digital television program includes the program rating information. According to this structure, the control portion can be formed to perform proper processing in response to a case where the program rating information is based on the variable rating table having the possibility that the contents thereof are changed and a case where the program rating information is based on the fixed rating table whose contents are not changed.

In this case, the control portion is preferably formed to perform parental control based on the fixed rating table without recognizing whether or not the rating table is updated from that at the time of recording of the digital television program if the program rating information of the reproduced digital television program is based on the fixed rating table at the time of reproduction of the digital television program including the program rating information. According to this structure, the control portion may not confirm updating when the program rating information is based on the unupdated fixed rating table dissimilarly to the case of the variable rating table, whereby processing at the time of reproduction of the digital television program including the program rating information can be simplified.

In the aforementioned structure related to the rating information including the rating table, the control portion is preferably formed to perform parental control of the digital television program on the basis of the rating table without informing the user that the reproduced digital television program includes the program rating information if the rating table at the time of reproduction is not updated from the rating table at the time of recording when reproducing the digital television program including the program rating information. According to this structure, the control portion can perform parental control of the recorded digital television program with setting made by the user in relation to parental control when the rating table at the time of reproduction is not updated from that at the time of recording.

In the aforementioned structure related to the rating information including the rating table, the rating table is preferably an RRT (Rating Region Table) based on ATSC A/65C (Program and System Information Protocol) according to ATSC (Advanced Television Systems Committee). According to this structure, the control portion can perform parental control with the RRT (rating table) based on ATSC A65/C.

A parental control method for a digital television program according to a second aspect of the present invention includes the steps of recognizing whether or not rating information used as the criterion for parental control is updated from that at the time of recording of a digital television program when reproducing the recorded digital television program and inquiring of the user as to whether or not to perform parental control of the digital television program if the rating information is updated from that at the time of recording of the digital television program at the time of reproduction.

In the parental control method for a digital television program according to the second aspect, as hereinabove described, whether or not the rating information is updated from that at the time of recording of the digital television program is recognized at the time of reproduction of the digital television program recorded in a recording storage portion and the user is asked to confirm whether or not to perform parental control of the digital television program if the rating information is updated, whereby whether or not the rating information is updated can be recognized at the time of reproduction of the recorded digital television program and the user can be asked to confirm whether or not to perform parental control of the digital television program also when the rating information is updated. Thus, the user can reperform parental control of a program having a possibility of being cut off at the time of recording also after the contents of the rating information are changed due to updating, whereby false reproduction of a program intended by the user to be cut off can be suppressed.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing the structure of a digital broadcast recording/reproducing apparatus according to an embodiment of the present invention;

FIGS. 2 to 5 are diagrams for illustrating parental control set screens according to RRTs of the digital broadcast recording/reproducing apparatus according to the embodiment shown in FIG. 1;

FIG. 6 is a diagram showing the structure of a rating table (RRT) of the digital broadcast recording/reproducing apparatus according to the embodiment of the present invention;

FIG. 7 is a diagram showing the structure of program rating information included in a digital television program received by the digital broadcast recording/reproducing apparatus according to the embodiment of the present invention;

FIG. 8 is a diagram showing an exemplary structure of a variable RRT of the digital broadcast recording/reproducing apparatus according to the embodiment of the present invention at the time of recording;

FIG. 9 is a diagram showing an exemplary structure of the variable RRT of the digital broadcast recording/reproducing apparatus according to the embodiment of the present invention at the time of reproduction;

FIG. 10 is a flow chart for illustrating an operation at the time of reproduction of a recorded program in the digital broadcast recording/reproducing apparatus according to the embodiment of the present invention; and

FIG. 11 is a diagram showing a screen display at the time of reproduction of the digital television program including the program rating information in the digital broadcast recording/reproducing apparatus according to the embodiment of the present invention.

### DESCRIPTION OF THE PREFERRED EMBODIMENTS

An embodiment of the present invention is now described with reference to the drawings.

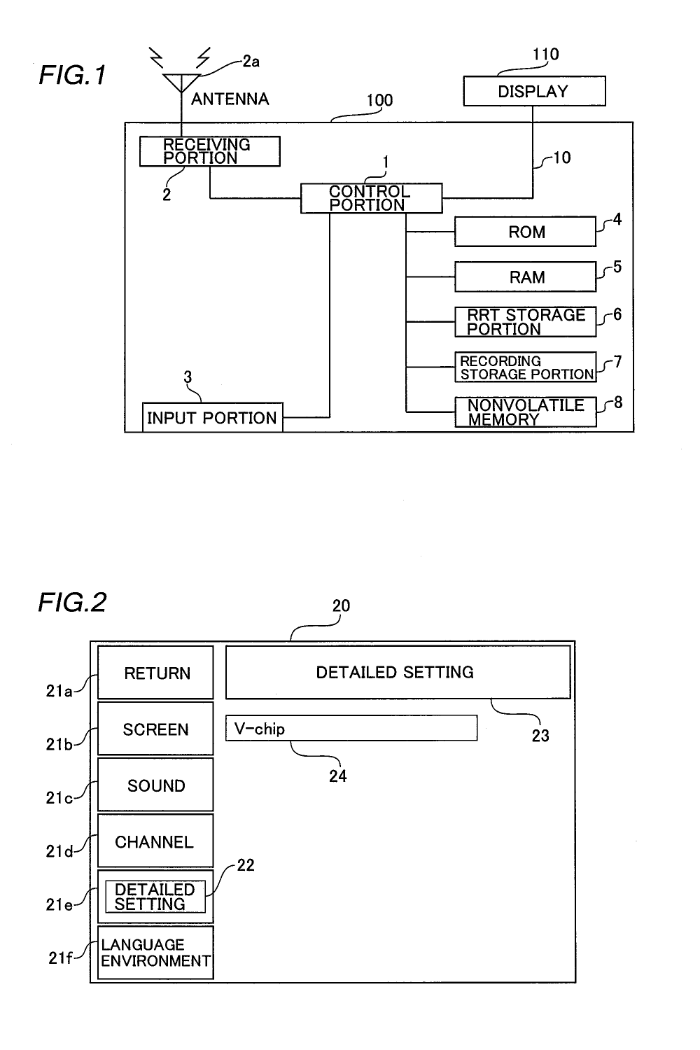

First, the structure of a digital broadcast recording/reproducing apparatus 100 according to the embodiment of the present invention is described with reference to FIG. 1.

As shown in FIG. 1, the digital broadcast recording/reproducing apparatus 100 includes a control portion 1 controlling the overall digital broadcast recording/reproducing apparatus 100, a receiving portion 2 receiving a digital broadcast signal supplied from a broadcast station through an antenna 2a, an input portion 3 for changing a volume, a channel etc., changing setting and the like, a ROM 4 storing programs run by the control portion 1 and data, a RAM 5 temporarily storing arithmetic data etc. by the control portion 1, an RRT storage portion 6 storing rating tables (RRTs) (fixed and variable RRTs), a recording storage portion 7 storing a received digital broadcast program and a nonvolatile memory 8 rewritably storing set information etc. of the digital broadcast recording/reproducing apparatus 100. The RRT storage portion 6 is an example of the “rating storage portion” in the present invention. The term “rating table (RRT)” denotes an RRT (Rating Region Table) based on ATSC A/65C (Program and System Information Protocol) according to ATSC (Advanced Television Systems Committee), and the structure described in this embodiment is according to the aforementioned standard. The RRTs are examples of the “rating table” in the present invention. The RRTs include the fixed RRT unrewritably stored at the time of shipping of the digital broadcast recording/reproducing apparatus 100 and the variable RRT included in the digital broadcast signal and updatably stored. The fixed RRT and the variable RRT are examples of the “fixed rating table” and the “variable rating table” in the present invention respectively.

The digital broadcast recording/reproducing apparatus 100 is connected with a display 110 through a cable 10. The control portion 1 is formed to output images of a digital television program extracted from the digital broadcast signal and an OSD (On Screen Display) signal for setting the digital broadcast recording/reproducing apparatus 100 on a screen of the display 110 to the display 110 through the cable 10.

The control portion 1 of the digital broadcast recording/reproducing apparatus 100 is electrically connected with the receiving portion 2, the input portion 3, the ROM 4, the RAM 5, the RRT storage portion 6, the recording storage portion 7 and the nonvolatile memory 8 respectively. The control portion 1 is formed to accept a channel selection signal from the input portion 3 and output the same to the receiving portion 2, and to receive a digital broadcast signal of a channel responsive to the channel selection signal from the receiving portion 2. The control portion 1 is formed to perform prescribed signal processing including extraction of various data including an image signal, a sound signal and program rating information and decoding of the data on the digital broadcast signal and to thereafter output the image signal and the sound signal as extracted to the display 110 through the cable 10. The image signal output from the control portion 1 is displayed on the display 110, while the sound signal is converted to a sound by a speaker (not shown) or the like and the sound is output. Thus, the user can view the digital television program of the channel-selected digital broadcast. The digital broadcast signal includes rating information used as the criterion for parental control of the digital television program, in addition to the image signal and the sound signal of the digital television program. The rating information includes program rating information indicating the rating of each digital television program and an updatable RRT (variable RRT) having a plurality of program rating information. The program rating information and the RRT (variable RRT) are examples of the “rating information” in the present invention respectively.

The control portion 1 is formed to accept an operation signal from the input portion 3 and to set the digital broadcast recording/reproducing apparatus 100. More specifically, the control portion 1 is formed to associate the channel selection signal received in the input portion 3 with the channel of the digital broadcast signal supplied from each broadcast station (channel setting). Further, the control portion 1 is formed to set the positions and the picture quality of images output to the display 110, the tone quality of sounds output to the speaker and the like, and to set a language displayed on the display 110.

According to this embodiment, the control portion 1 is formed to perform parental control of the digital television program including the program rating information on the basis of the rating information (RRT) stored in the RRT storage portion 6. In order to perform parental control of the digital television program including the program rating information, the user selects a rating (hereinafter referred to as an inhibited rating) intended by the user to be subjected to parental control (cut off) from a set screen displaying the RRT and stores the same in the nonvolatile memory 8.

The control portion 1 is formed to record a digital television program selected by the user by outputting image data and sound data of the digital television program to the recording storage portion 7 on the basis of the operation signal from the input portion 1. At this time, the control portion 1 also outputs the program rating information of the recorded digital television program and program information including the variable RRT to the recording storage portion 7 and stores the same in the recording storage portion 7. Further, the control portion 1 is formed to reproduce the recorded digital television program in response to the user's selection by reading the image data and the sound data stored in the recording storage portion 7 and outputting the same to the display 110 on the basis of the operation signal from the input portion 3.

According to this embodiment, the control portion 1 is formed to recognize whether or not the variable RRT is updated by comparing information related to updating of the variable RRT at the time of recording of the digital television program with information related to updating of the variable RR at the time of reproduction of the digital television program. The information related to updating of the variable RRT includes version information of the variable RRT.

More specifically, the control portion 1 is formed to recognize whether or not the RRT is updated from that at the time of recording of the digital television program including the program rating information by comparing the version information of the RRT in the RRT storage portion 6 with the version information of the RRT at the time of recording of the digital television program including the program rating information when reproducing the digital television program including the program rating information stored in the recording storage portion 7. The control portion 1 is formed to display a message indicating that the reproduced digital television program includes the program rating information on the display 110 for informing the user that the reproduced digital television program includes the program rating information and to confirm whether or not to execute reproduction of the digital television program including the program rating information if the variable RRT is updated. The processing at the time of reproducing the recorded digital television program is described later in detail.

The receiving portion 2 is formed to extract the digital broadcast signal of the channel (broadcast station) corresponding to the channel selection signal from digital broadcast signals received by the antenna 2a, to perform A-D conversion and the like, and to output the A-D converted signal to the control portion 1.

The input portion 3 is formed to receive the channel selection signal and the operation signal by infrared rays or the like transmitted from a remote controller (not shown) or the like and to output the same to the control portion 1. The user transmits the channel selection signal and the operation signal to the input portion 3, thereby changing the volume, the channel etc. and changing the setting. The input portion 3 is provided with a plurality of buttons (not shown), so that the user can directly operate the digital broadcast recording/reproducing apparatus 100 without employing the remote controller or the like.

The ROM 4 stores the programs and the data for making the control portion 1 execute various functions and controls. The control portion 1 is formed to read the programs from the ROM 4 and to perform various controls on the basis of the operation signal from the input portion 3.

The RAM 5 is a memory temporarily storing data when the control portion 1 performs an arithmetic operation such as data processing.

The RRT storage portion 6 is formed by a rewritable nonvolatile memory, and has a function of storing the RRT for performing parental control of the digital television program including the program rating information. The fixed RRT is mainly clarified into two types and consists of a TV rating related to parental control of television broadcast programs and an MPAA rating related to parental control of movies or the like recorded in recording media such as DVDs, while the TV rating includes a plurality of RRTs further subdivided in response to broadcast districts.

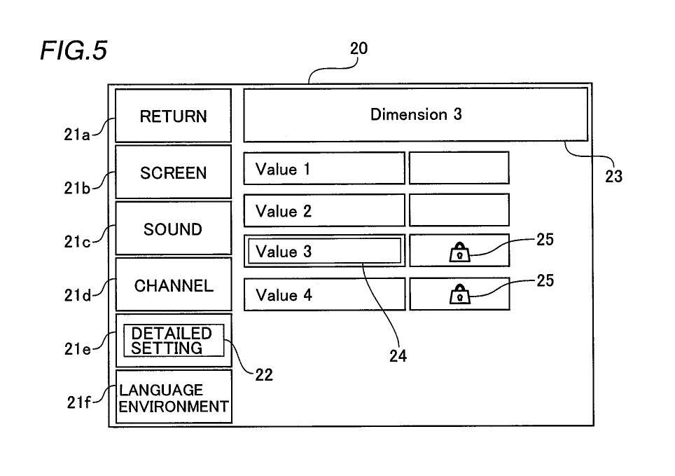

The recording storage portion 7 is formed by a rewritable nonvolatile memory, and has a function of storing the image data and the sound data of the digital television program received from the control portion 1 thereby recording the digital television program. The control portion 1 reads the digital television program recorded in the recording storage portion 7, thereby reproducing the same. The control portion 1 is formed to also output program information including the program rating information of the recorded digital television program and the variable RRT, the date of recording and the like and to store the same in the recording storage portion 7 when recording the digital television program. As hereinafter described, the variable RRT includes version information (FIG. 6) thereof. In other words, the recording storage portion 7 stores the variable RRT, including the version information, at the time of recording along with the digital television program when recording the digital television program.

The nonvolatile memory 8 has a function of rewritably storing the set information etc. of the digital broadcast recording/reproducing apparatus 100 received from the control portion 1. The nonvolatile memory 8 is formed to store the set information etc. of the digital broadcast recording/reproducing apparatus 100 such as set information of the inhibited rating based on the RRT, image display on the display 110 and sound output and to rewrite the same if the setting is changed.

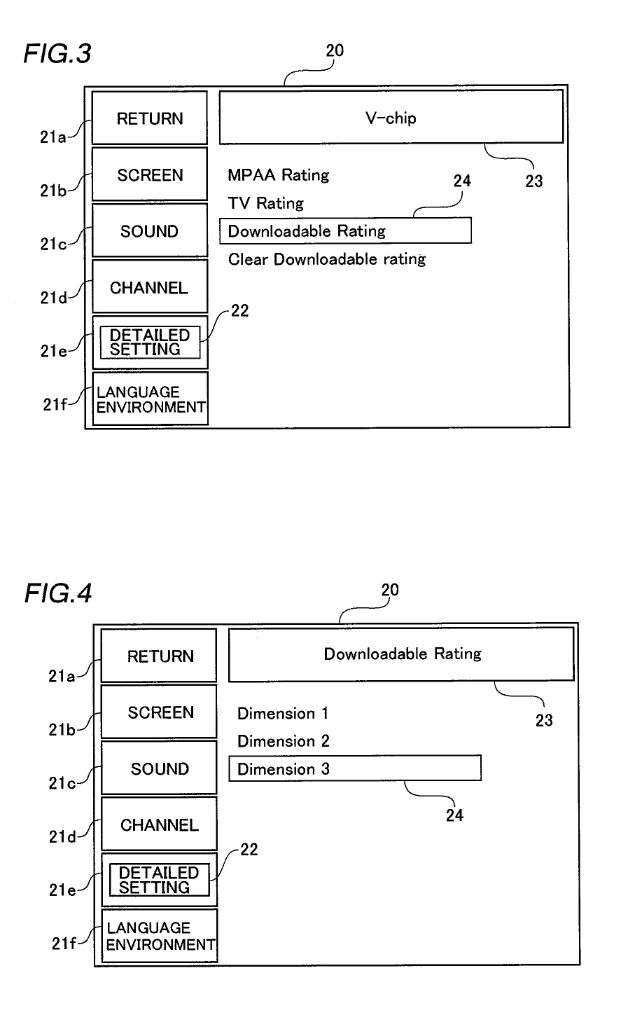

A set operation of the digital broadcast recording/reproducing apparatus 100 according to this embodiment for performing parental control of the digital television program is now described with reference to FIGS. 2 to 9.

As the set operation for performing parental control of the digital television program with the RRT, the user previously selects the inhibited rating intended by the user to be subjected to parental control (cut off) from the set screen displaying the RRT and stores the same in the nonvolatile memory 8. The control portion 1 sets the inhibited rating on the basis of the operation signal output by the user and received from the input portion 3.

More specifically, the user performs the set operation of the digital broadcast recording/reproducing apparatus 100 including parental control by displaying a set screen 20 according to the OSD signal by operating the remote controller or the like, as shown in FIG. 2. The set screen 20 displays items 21a to 21f. The item 21a is an item for returning from the set screen 20 to an ordinary screen of the digital television program. The subsequent items 21b to 21f are items for setting the digital broadcast recording/reproducing apparatus 100 in various ways, and the items 21b, 21c and 21d are items for setting the screen display, the sound output and the selected channel respectively. The item 21e includes an item for setting parental control with the RRT. The item 21f is an item for setting the language displayed on the set screen 20 or the like. The user sets the parental control with the RRT by vertically moving a cursor 22 and selecting the item 21e. A display field 23 displays the item 21e selected through the cursor 22, and set items are enumerated under the display field 23. Referring to FIG. 2, an item “V-chip” is displayed and selected through the cursor 24.

When the user selects the item “V-chip” through the cursor 24 as shown in FIG. 3, items for setting parental control based on various RRTs are displayed. At this time, the display field 23 displays the item name “V-chip”, and the RRTs are enumerated under the display field 23. “MPAA Rating” and “TV Rating” denote fixed RRTs. “Downloadable Rating” denotes a variable RRT. The user sets parental control with the variable RRT by moving the cursor 24 and selecting “Downloadable Rating”. The user can erase the variable RRT from the RRT storage portion 6 by selecting “Clear Downloadable Rating” through the cursor 24.

When the user selects the item “Downloadable Rating” as shown in FIG. 4, rating items (Dimensions) set in the variable RRT are displayed. The rating items are provided correspondingly to the manners of parental control. More specifically, a plurality of different items such as parental control in consideration of the age of the viewer, parental control in consideration of the contents (strength of violent expression or the like) of the program, parental control in consideration of the manner of supply of the variable RRT specific to the broadcast station and the like are provided as the rating items. The user selects the rating item (Dimension) to be set through the cursor 24, and performs setting every rating item.

When the user selects the rating item “Dimension 3” as shown in FIG. 5, the item name “dimension 3” is displayed on the display field 23, and the levels (Values) of the rating item (Dimension 3) are enumerated. The rating item (Dimension 3) shown in FIG. 5 is provided with four levels (Values 1 to 4). In other words, the rating item (Dimension 3) indicates that the contents of the broadcast digital television program are classified into four stages on the basis of prescribed criteria (the age of the viewer, the strength of violent expression and the like) for performing parental control. The user selects desired levels from Values 1 to 4 through the cursor 24, and cuts off (performs parental control of) the program. Key marks 25 indicating that parental control is performed are displayed on the levels selected by the user. Thus, the control portion 1 sets the inhibited rating by recognizing which levels (Values 3 and 4 in FIG. 5) of which rating item (Dimension 3 in FIG. 5) in the variable RRT are cut off and storing the setting in the nonvolatile memory 8. The control portion 1 refers to the program rating information included in the digital television program and reads the inhibited rating selected from the RRT by the user from the nonvolatile memory 8 when the user views the received digital television program including the program rating information or reproduces the recorded digital television program including the program rating information. If the rating of the digital television program corresponds to the inhibited rating, the control portion 1 cuts off the images and the sounds, and executes parental control. Thus, the control portion 1 limits (cuts off) viewing of the digital television program including the rating matching with the inhibited rating regarded by the caretaker, i.e., the user, as improper for the child.

As hereinabove described, the variable RRT includes the rating items (Dimensions) and the levels (Values), and a table consisting of at least one rating item (Dimension) and at least one level (Value) as to each rating item is constituted in each RRT. Each fixed RRT has a structure substantially similar to that of the variable RRT. Data in the fixed RRT remain unchanged. In the variable RRT, on the other hand, the numbers of the rating items and the levels are increasable and reducible, and vary with each broadcast station supplying the variable RRT. When the variable RRT is updated, therefore, the names and the numbers of the rating items (Dimensions) and the levels (Values) are changeable. Thus, the variable RRT includes the version information, which is rewritten every time the variable RRT is updated. Therefore, the control portion 1 can recognize whether or not the variable RRT is updated and the contents thereof are changed by confirming the version information included in the variable RRT.

The variable RRT includes various data related to the rating, as shown in FIG. 6. The version of the variable RRT is stored in “version_number” 31. When the RRT storage portion 6 updates the variable RRT by storing a new variable RRT supplied from the broadcast station, the “version_number” 31 is also revised. The variable RRT is included in the digital broadcast signal from each broadcast station, and acquired along with the image data, the sound data and the program rating information included in the program information. When the supplied variable RRT is updated, the same is stored in the RRT storage portion 6 by the control portion 1, and rewritten to the latest version. On the other hand, the variable RRT is stored in the recording storage portion 7 along with the program information and the program rating information when the digital television program is recorded. Therefore, the recorded digital television program is stored in the recording storage portion 7 along with the RRT of the version at the time of recording.

The number (three in FIG. 4) of the rating items (Dimensions) included in the variable RRT is stored in “dimensions_defined” 32. The names (Dimensions 1 to 3 in FIG. 4) of the rating items are stored in “dimension_name text( )” 33. The numbers of the levels of the rating items are stored in “values_defined” 34, while the names (Values 1 to 4 in FIG. 5) of the levels are stored in “rating_value_text( )” 35. The numbers (“dimensions_defined” 32) of the rating items, the names (“dimension_name_text( )” 33) of the rating items, the numbers (“values_defined” 34) of the levels of the rating items and the names (“rating_value_text( )” 35) of the levels are changeable and increasable/reducible, and formed to be changeable following updating of the variable RRT. An identifier specifying the variable RRT is stored in “rating_region” 36. An identifier specifying each fixed RRT is stored in “rating_region” of the fixed RRT, and hence the fixed RRT and the variable RRT are distinguished from each other through “rating_region” 36.

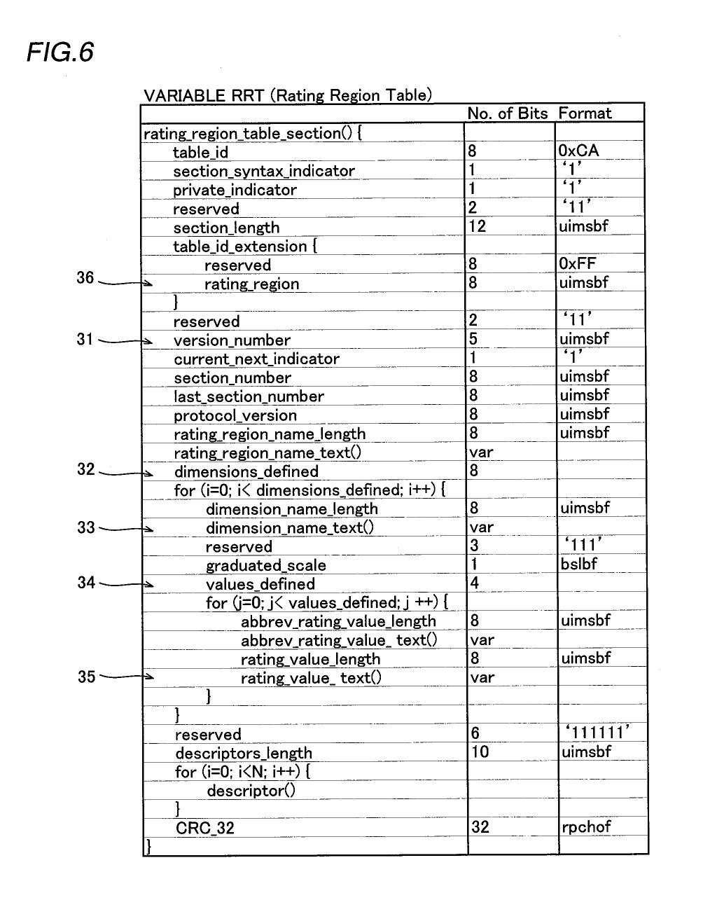

On the other hand, the rating items (Dimensions) of the RRT and the levels (Values) of the rating items are described in the program rating information included in the digital television program. Further, the program rating information includes identifiers indicating on which RRT the described rating items and the described levels are based. The identifiers are associated with either the variable RRT or the fixed RRT. Therefore, the program rating information indicates to which level of which rating item of which RRT the digital television program including the program rating information corresponds. More specifically, the program rating information includes data shown in FIG. 7. In the program rating information, “rating_dimension_j” 41 and “rating value” 42 store the value of the rating item (Dimension) of the digital television program and the value of the level (Value) of the rating item respectively. Further, “rating_region” 43 stores an identifier specifying a prescribed fixed or variable RRT, to specify on which RRT the program rating information is based. If the identifier stored in “rating_region” 43 of the program rating information matches with the identifier stored in “rating_region” 36 (see FIG. 6), therefore, this indicates that the program rating information is based on the variable RRT. Thus, the program rating information is formed to indicate to which level (Value) of which rating item (Dimension) of which RRT the same corresponds.

As described above, the user sets the inhibited rating by selecting a prescribed level (Value) of a prescribed rating item (Dimension) of the RRT. In viewing of the digital television program, the control portion 1 compares a specific RRT included in the program rating information, the rating item and the level with the rating item and the level of the inhibited rating of the corresponding RRT, and performs parental control of the digital television program by cutting off the program if the rating of the digital television program corresponds to the inhibited rating.

The aforementioned program rating information includes no information specifying the version of the variable RRT. When the variable RRT is updated and the contents of the rating items and the levels are changed, therefore, the program rating information cannot follow the changes. If the broadcast station updates the variable RRT in a real-time broadcast, the program rating information of the broadcast digital television program is also corrected to that corresponding to the latest variable RRT in response thereto. If the digital television program including the program rating information is recorded and the variable RRT is updated before subsequent reproduction thereof, however, it follows that the program rating information indicates the level of a prescribed rating item in an RRT of a different version. If the contents (the numbers of the rating items and the levels) of the variable RRT are changed following updating of the variable RRT, the program rating information at the time of recording and that at the time of reproduction (after updating of the variable RRT) may indicate different ratings due to different variable RRTs setting the contents of the ratings.

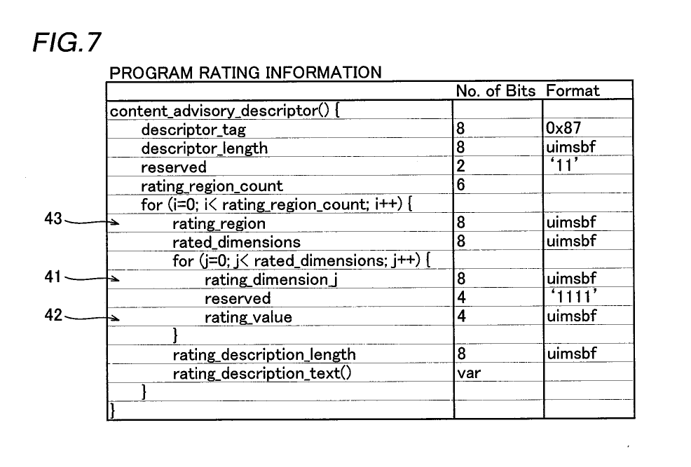

An exemplary case where the versions of a variable RRT are different from each other at the time of recording of a digital television program and at the time of reproduction thereof is now described. As shown in FIG. 8, it is assumed that the variable RRT at the time of recording includes three rating items (Dims. 1 to 3), each of Dim. 1 and Dim. 2 includes four levels (Values 1 to 4), and Dim. 5 includes five levels (Values 1 to 5). It is also assumed that Value 4 of Dim. 2 and Values 3 to 5 of Dim. 3 are set to inhibited ratings.

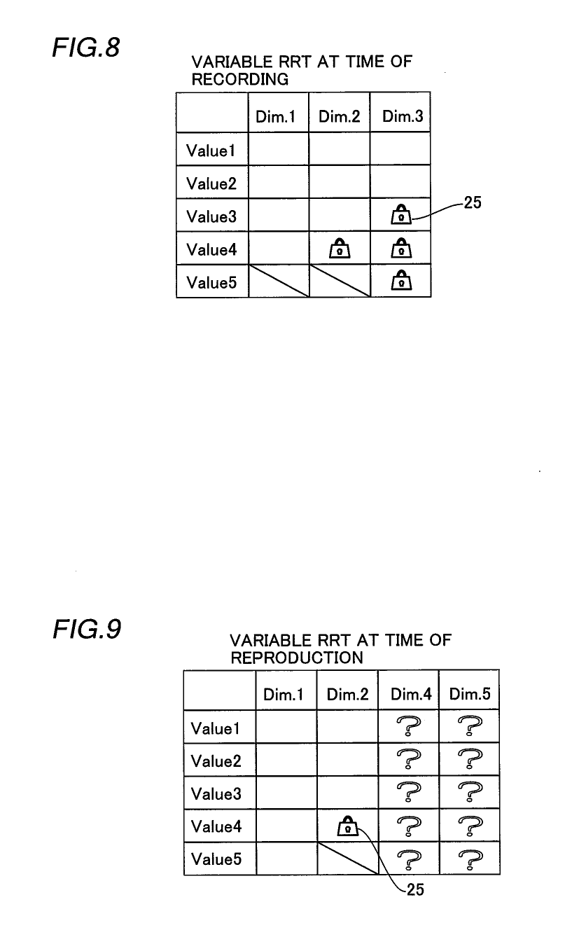

As shown in FIG. 9, it is further assumed that Dim. 3 is deleted from the variable RRT at the time of reproduction by updating and Dim. 4 (values 1 to 5) and Dim. 5 (Values 1 to 5) are newly added thereto. It is also assumed that the levels of Dim. 1 are subdivided from the four stages (Values 1 to 4) to five stages (Values 1 to 5) due to the updating.

When the digital television program to be reproduced has program rating information indicating Value 4 of Dim. 3 in the variable RRT at the time of recording shown in FIG. 8, it is understood that the digital television program has contents whose reproduction must be cut off according to the setting of the inhibited ratings in the RRT at the time of recording. However, the program rating information includes no information specifying the version of the variable RRT as shown in FIG. 7, and hence it follows that Dim. 3 in the updated variable RRT shown in FIG. 9 is specified at the time of reproduction. However, Dim. 3 is deleted from the updated variable RRT (at the time of reproduction), and hence it is unclear whether or not the rating of the digital television program corresponds to the inhibited rating. If the control portion 1 recognizes that Value 4 of Dim. 3 is not set to the inhibited rating at this time, it follows that the program originally intended by the user to be cut off is rendered viewable. If the levels are subdivided or integrated due to updating of the variable RRT and the contents of the rating item indicated by each level themselves are changed as in Dim. 1 shown in FIGS. 8 and 9 in addition to the aforementioned example, such a situation can take place that the inhibited rating does not match with the contents of the program rating information and the program is cut off or reproduced against the user's intension.

As hereinabove described, there is a possibility that a digital television program set by the user to the inhibited rating is falsely reproduced if the versions of the variable RRT are different from each other at the time of recording of the digital television program and at the time of reproduction thereof. According to this embodiment, therefore, the control portion 1 displays the message indicating that the reproduced digital television program includes the program rating information on the display 110 for informing the user that the reproduced digital television program includes the program rating information and confirms whether or not to execute reproduction of the digital television program including the program rating information if the variable RRT is updated.

A control operation of the digital broadcast recording/reproducing apparatus 100 according to this embodiment at the time of reproduction of the recorded program is now described with reference to FIGS. 6, 7, 10 and 11.

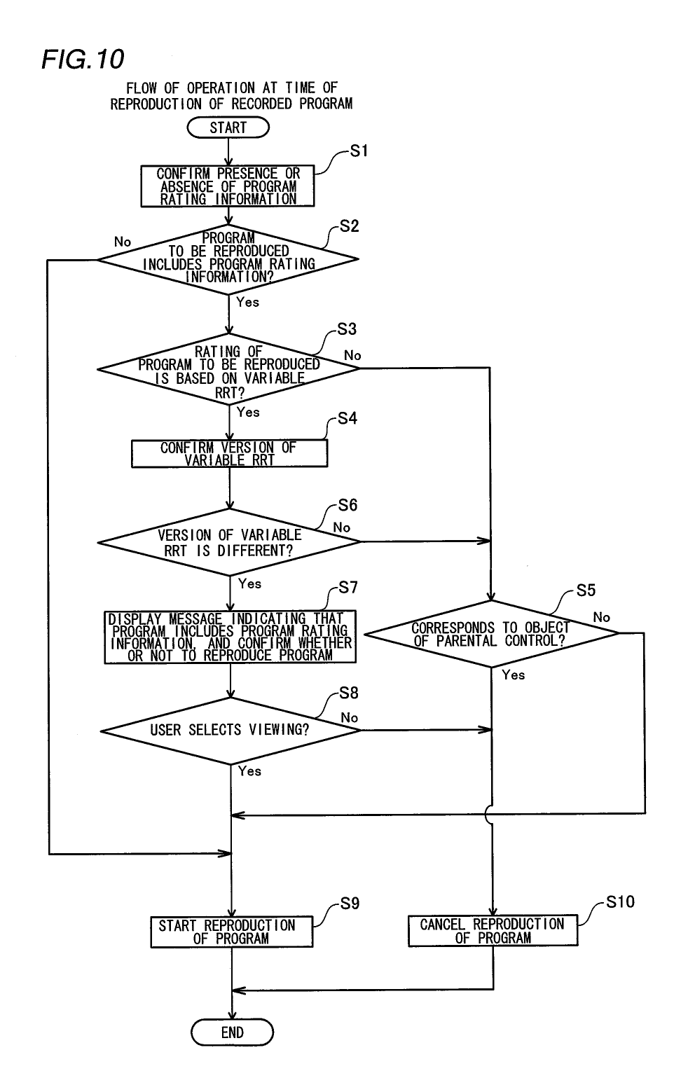

The control portion 1 executes this control operation when reproducing the digital television program stored in the recording storage portion 7 on the basis of an operation input by the user received through the input portion 3. As shown in FIG. 10, the control portion 1 reads data stored in the recording storage portion 7 and confirms the presence or absence of the program rating information of the digital television program to be reproduced at a step S1.

If determining that the digital television program to be reproduced includes the program rating information at a step S2, the control portion 1 advances to a step S3. If the digital television program to be reproduced does not include the program rating information, on the other hand, the control portion 1 may not perform parental control. Therefore, the control portion 1 advances to a step S9 and executes reproduction of the digital television program without confirming whether or not the variable RRT is updated.

If the digital television program to be reproduced includes the program rating information, the control portion 1 determines whether or not the rating (program rating information) of the digital television program to be reproduced is based on the variable RRT at the step S3. More specifically, the control portion 1 refers to the identifier stored in “rating_region” 43 (see FIG. 7) of the program rating information included in the digital television program, and determines whether or not the same matches with the identifier stored in “rating_region” 36 (see FIG. 6) of the variable RRT. If the identifier stored in “rating_region” 43 (see FIG. 7) of the program rating information is different from the identifier of the variable RRT, the identifier of the fixed RRT is stored in the program rating information.

If determining that the rating (program rating information) of the digital television program to be reproduced is based on the variable RRT at the step S3, the control portion 1 advances to a step S4. At the step S4, the control portion 1 refers to the version information (“version_number” 31) (see FIG. 6) of the latest variable RRT stored in the RRT storage portion 6, and confirms the version of the latest variable RRT. Further, the control portion 1 reads the variable RRT (at the time of recording) recorded along with the digital television program to be reproduced from the recording storage portion 7, and confirms the version of the variable RRT at the time of recording from the version information (“version_number” 31) (see FIG. 6).

If determining that the identifier stored in “rating_region” 43 (see FIG. 7) of the program rating information does not match with the identifier stored in “rating_region” 36 (see FIG. 6) of the variable RRT at the step S3, on the other hand, the control portion 1 advances to a step S5. In this case, the program rating information is based on the fixed RRT. In this case, the control portion 1 executes parental control on the basis of the inhibited rating of the fixed RRT without recognizing updating of the RRT (fixed RRT) between the time of recording and the time of reproduction. In other words, the control portion 1 refers to the inhibited rating of the fixed RRT from the nonvolatile memory 8, and determines whether or not the rating included in the program rating information corresponds to the inhibited rating of the fixed RRT. Thus, the control portion 1 determines whether or not the digital television program to be reproduced corresponds to an object of parental control. If the digital television program to be reproduced does not correspond to the object of parental control, the control portion 1 advances to the step S9 and starts reproduction of the program. If the digital television program to be reproduced corresponds to the object of parental control, on the other hand, the control portion 1 advances to a step S10 and cancels reproduction of the program.

After confirming the version of the variable RRT at the step S4, the control portion 1 determines at a step S6 whether or not the version of the variable RRT at the time of recording of the digital television program to be reproduced matches with the version of the (latest) variable RRT at the time of reproduction. Thus, the control portion 1 recognizes whether or not the variable RRT is updated from that at the time of recording of the digital television program to be reproduced. If the versions of the variable RRT match with each other, the control portion 1 advances to the step S5. If the versions of the variable RRT are different from each other, on the other hand, the control portion 1 advances to a step S7.

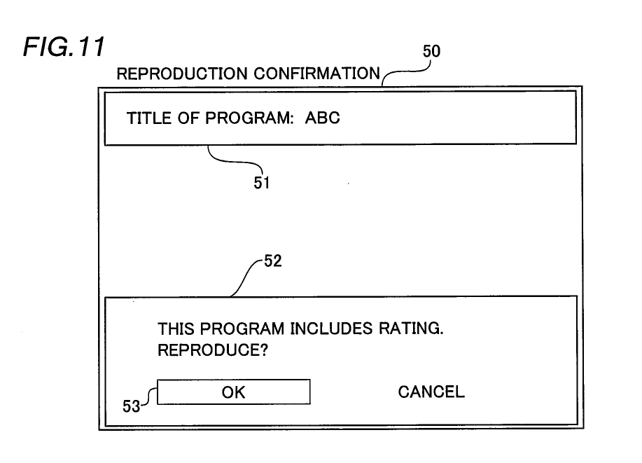

If the versions of the variable RRT at the time of recording of the digital television program and at the time of reproduction thereof are different from each other, the control portion 1 displays the message indicating that the digital television program to be reproduced includes the program rating information, and outputs a display inquiring of the user as to whether or not to reproduce the digital television program to the display 110 at the step S7. More specifically 11, the display 11 OSD-displays a message screen 50, as shown in FIG. 11. Referring to FIG. 11, a display field 51 displays the title of the program to be reproduced. Another display field 52 displays the message indicating that the digital television program to be reproduced includes the program rating information and inquiring of the user as to whether or not to reproduce the digital television program while selectably displaying options “OK” and “cancel”, so that the user selects whether or not to reproduce the digital television program through a cursor 53. Thus, the display 110 displays the message indicating that the digital television program to be reproduced includes the program rating information and the title of the digital television program as well as the options as to whether or not to reproduce the digital television program at the step S7.

If determining that the user selects the option “OK (the program is viewed)” selectably displayed on the display 110 as shown in FIG. 11 at the step S8, the control portion 1 advances to the step S9 and executes reproduction of the digital television program. If determining that the user selects the option “cancel (the program is not viewed)” selectably displayed on the display 110, on the other hand, the control portion 1 advances to the step S10 and cancels reproduction of the recorded digital television program.

If determining that the version of the variable RRT at the time of recording of the digital television program to be reproduced matches with the version of the variable RRT at the present time of reproduction at the step S6, the control portion 1 advances to the step S5 and determines whether or not the rating of the digital television program to be reproduced corresponds to the set inhibited rating. In this case, the control portion 1 performs parental control of the digital television program on the basis of the variable RRT without informing the user that the digital television program to be reproduced includes the program rating information. In other words, the control portion 1 determines whether or not the rating item and the level of the variable RRT set by the user to the inhibited rating match with the rating item and the level indicated by the program rating information of the digital television program.

If determining that the rating of the digital television program to be reproduced does not correspond to the inhibited rating set by the user at the step S5, the control portion 1 advances to the step S9 and reproduces the digital television program. If determining that the rating of the digital television program to be reproduced corresponds to the inhibited rating set by the user at the step S5, on the other hand, the control portion 1 advances to the step S10, cuts off and cancels reproduction of the digital television program.

As hereinabove described, the control portion 1 confirms the versions of the variable RRT at the time of reproduction of the digital television program recorded in the recording storage portion 7, and inquires of the user as to whether or not to reproduce the digital television program if the versions are different from each other. The control portion 1 performs this operation control every time the same reproduces the digital television program recorded in the recording storage portion 7. In other words, the control portion 1 executes the operation control every time the same reproduces the recorded digital television program including the program rating information.

According to this embodiment, as hereinabove described, the control portion 1 is formed to recognize whether or not the rating information (variable RRT) is updated from that at the time of recording of the digital television program including the program rating information when reproducing the digital television program including the program rating information recorded in the recording storage portion 7 and to inquire of the user as to whether or not to perform parental control of the digital television program including the program rating information if the rating information (variable RRT) is updated at the time of reproduction, whereby the control portion 1 can recognize whether or not the variable RRT is updated when reproducing the recorded digital television program including the program rating information and can inquire of the user as to whether or not to perform parental control (whether to perform or cancel reproduction) of the digital television program including the program rating information also when the variable RRT is updated. Thus, the user can reperform parental control (cancel reproduction) of the digital television program having a possibility of being cut off at the time of recording also when the contents of the variable RRT are changed due to updating, whereby false reproduction of the program intended by the user to be cut off can be suppressed.

According to this embodiment, as hereinabove described, the control portion 1 is formed to recognize whether or not the variable RRT is updated from that at the time of recording of the digital television program when reproducing the digital television program including the program rating information and to inquire of the user as to whether or not to perform parental control of the digital television program including the program rating information if the variable RRT is updated at the time of reproduction. According to this structure, the control portion 1 can inquire of the user as to whether or not to perform parental control of the digital television program when reproducing the digital television program including the program rating information also when the variable RRT is updated between the time of recording of the digital television program including the program rating information and the time of reproduction thereof and the contents (Dimensions and Values) of the variable RRT are changed.

According to this embodiment, as hereinabove described, the control portion 1 is formed to recognize whether or not the variable RRT at the time of reproduction is updated by comparing the version information (“version_number” 31) (see FIG. 6) of the variable RRT at the time of recording setting the program rating information of the recorded digital television program with the version information (“version_number” 31) of the variable RRT at the time of reproduction stored in the RRT storage portion 6, whereby the control portion 1 can easily recognize whether or not the variable RRT is updated between the time of recording and the time of reproduction.

According to this embodiment, as hereinabove described, the control portion 1 is formed to inform the user that the reproduced digital television program includes the program rating information and to confirm whether or not to reproduce the digital television program if the variable RRT at the time of reproduction is updated from the variable RRT at the time of recording when reproducing the digital television program including the program rating information, whereby the user can determine whether or not to reproduce the recorded digital television program after recognizing that the reproduced digital television program includes the program rating information. Thus, the user can recognize the possibility that the reproduced digital television program is a program intended by him/her to be cut off (subjected to parental control) and can determine whether or not to reproduce the same at his/her own discretion, whereby false reproduction of a program intended by the user to be cut off can be more reliably suppressed.

According to this embodiment, as hereinabove described, the control portion 1 is formed to store the variable RRT at the time recording including the version information (“version_number” 31) (see FIG. 6) in the recording storage portion 7 along with the digital television program when recording the digital television program, whereby the control portion 1 may not add information associating the recorded digital television program with the variable RRT at the time of recording or the like to recorded data, but can store the digital television program and the variable RRT at the time of recording in the recording storage portion 7 as such.

According to this embodiment, as hereinabove described, the control portion 1 is formed to inform the user that the reproduced digital television program includes the program rating information by displaying the message indicating that the reproduced digital television program includes the program rating information on the display 110 so that the user can visually recognize that the reproduced digital television program includes the program rating information through the message OSD-displayed on the display 110 displaying the images of the digital television program when reproducing the digital television program, whereby the control portion 1 can reliably inform the user that the reproduced digital television program includes the program rating information dissimilarly to a case of informing the user that the reproduced digital television program includes the program rating information with a sound or the like.

According to this embodiment, as hereinabove described, the control portion 1 is formed to inquire of the user as to whether or not to perform parental control at the time of reproducing the recorded digital television program including the program rating information when the variable RRT is updated every time the same reproduces the recorded digital television program including the program rating information so that each user can reperform parental control of a program having a possibility of being cut off at the time of recording also when there are a plurality of users such as a caretaker and a child, for example, or no proper parental control has been set in precedent reproduction, whereby false reproduction of a program intended by the user to be cut off can be more reliably suppressed.

According to this embodiment, as hereinabove described, the control portion 1 is formed to selectably OSD-display the options (“OK” and “cancel”) (see FIG. 11) as to whether or not to reproduce the digital television program on the display 110, whereby the user can select whether or not to reproduce the digital television program from the options (“OK” and “cancel”) displayed on the message screen 50 of the display 110 after recognizing the possibility that the digital television program to be reproduced is a program intended by him/her to be cut off without a complicated operation such as cancellation of parental control setting (inhibited rating), for example.

According to this embodiment, as hereinabove described, the control portion 1 is formed to display the title of the recorded digital television program on the display field 51 of the display 110 in addition to the options (“OK” and “cancel”) when selectably OSD-displaying the options (“OK” and “cancel”) as to whether or not to reproduce the digital television program on the display 110. According to this structure, the user can grasp the contents of the program to some extent from the title or the like of the recorded digital television program when determining whether or not to reproduce the digital television program.

According to this embodiment, as hereinabove described, the control portion 1 is formed to reproduce a digital television program not including program rating information without recognizing whether or not the variable RRT is updated from that at the time of recording of the digital television program not including the program rating information if the recorded digital television program does not include the program rating information so that the control portion 1 reproduces the digital television program not including the program rating information and not requiring parental control without recognizing whether or not the variable RRT is updated and without inquiring of the user as to whether or not to perform parental control of the digital television program, whereby the control portion 1 can perform only parental control of the digital television program including the program rating information without forcing the user to perform an unnecessary operation.

According to this embodiment, as hereinabove described, the control portion 1 is formed to perform parental control based on the fixed RRT without recognizing whether or not the variable RRT is updated from that at the time of recording of the digital television program if the program rating information of the reproduced digital television program is based on the fixed RRT at the time of reproduction of the digital television program including the program rating information so that the control portion 1 may not confirm updating when the program rating information is based on the unupdated fixed RRT dissimilarly to the case of the variable RRT, whereby processing at the time of reproduction of the digital television program including the program rating information can be simplified.

According to this embodiment, as hereinabove described, the control portion 1 is formed to perform parental control of the digital television program on the basis of the variable RRT without informing the user that the reproduced digital television program includes the program rating information if the variable RRT at the time of reproduction is not updated from the variable RRT at the time of recording when reproducing the digital television program including the program rating information. According to this structure, the control portion 1 can perform parental control of the recorded digital television program with setting made by the user in relation to parental control when the variable RRT at the time of reproduction is not updated from that at the time of recording.

Although the present invention has been described and illustrated in detail, it is clearly understood that the same is by way of illustration and example only and is not to be taken by way of limitation, the spirit and scope of the present invention being limited only by the terms of the appended claims.

For example, while the digital broadcast recording/reproducing apparatus 100 is connected with the display 110 through the cable 10 in the aforementioned embodiment, the present invention is not restricted to this. According to the present invention, the digital broadcast recording/reproducing apparatus and the display may alternatively be integrally formed. In other words, the digital broadcast recording/reproducing apparatus may be stored in a digital television. Further alternatively, the digital broadcast recording/reproducing apparatus may be integrally formed with an apparatus such as the so-called set-top box, a home terminal or a tuner for receiving a digital television broadcast.

While the control portion 1 is formed to control the overall digital broadcast recording/reproducing apparatus 100 by outputting the image signal and the sound signal to the display 110 through the cable 10, accepting the operation signal from the input portion 3 and setting the digital broadcast recording/reproducing apparatus 100 in the aforementioned embodiment, the present invention is not restricted to this. According to the present invention, the control portion may not control the overall digital broadcast recording/reproducing apparatus. The control portion may simply be formed to record and reproduce the digital television program in and from the recording storage portion and to perform parental control of the digital television program based on the RRT stored in the rating storage portion. Therefore, a dedicated control portion controlling the overall digital broadcast recording/reproducing apparatus may alternatively be separately provided. Further alternatively, the control portion may be constituted of a plurality of control portions.

While the control portion 1 is formed to recognize whether or not the variable RRT is updated by comparing the version information of the variable RRT at the time of reproduction stored in the RRT storage portion 6 with the version information of the variable RRT at the time of recording of the digital television program including the program rating information in the aforementioned embodiment, the present invention is not restricted to this. According to the present invention, the control portion may alternatively be formed to recognize whether or not the variable RRT is updated by a method other than that of comparing the version information of the variable RRT. The control portion may alternatively be formed to recognize whether or not the variable RRT is updated between the time of recording of the digital television program and the time of reproduction thereof by comparing the date of recording of the digital television program with the date of updating of the variable RRT, for example. Further alternatively, the control portion may be formed to recognize updating of the variable RRT when the variable RRT is updated by adding information indicating that the variable RRT is updated to all digital television programs recorded in the recording storage portion at the time of updating and confirming this information at the time of reproduction, for example.

While the control portion 1 is formed to inform the user that the reproduced digital television program includes the program rating information by displaying the message indicating that the reproduced digital television program includes the program rating information on the display 110 and to confirm whether or not to reproduce the digital television program including the program rating information when the variable RRT is updated in the aforementioned embodiment, the present invention is not restricted to this. According to the present invention, the control portion may not inform the user that the reproduced digital television program includes the program rating information by displaying the message indicating that the reproduced digital television program includes the program rating information. The control portion may alternatively be formed to only confirm whether or not to reproduce the digital television program including the program rating information. Further alternatively, the control portion may be formed to inform the user that the variable RRT is updated and that there is a possibility that the rating of the reproduced digital television program has corresponded to the inhibited rating in the variable RRT at the time of recording. If the variable RRT is updated, the control portion may inquire of the user as to whether or not to perform parental control of the digital television program including the program rating information.

While the control portion 1 is formed to inquire of the user as to whether or not to reproduce the recorded digital television program including the program rating information if the variable RRT is updated every time the same reproduces the recorded digital television program including the program rating information in the aforementioned embodiment, the present invention is not restricted to this. According to the present invention, the control portion may not inquire of the user as to whether or not to reproduce the digital television program every time the same reproduces the recorded digital television program including the program rating information. The control portion may alternatively be formed to inquire of the user as to whether or not to reproduce the digital television program and to newly inquire of the user as to whether or not to set parental control of the digital television program including the program rating information.

While the control portion 1 is formed to store the setting of the inhibited rating based on the RRT in the nonvolatile memory 8 in the aforementioned embodiment, the present invention is not restricted to this. According to the present invention, the control portion 1 may not store the set information of the inhibited rating in the nonvolatile memory 8, but may alternatively be formed to store the set information of the inhibited rating in the RRT storage portion 6 or the recording storage portion 7.

While the recording storage portion 7 is formed to store the variable RRT at the time of recording along with the digital television program when recording the digital television program in the aforementioned embodiment, the present invention is not restricted to this. The recording storage portion 7 may alternatively be formed to store only the version information (“version_number” 31) (see FIG. 6) of the variable RRT at the time of recording when recording the digital television program, for example. Further alternatively, the RRT storage portion 6 may be formed to store all versions of the variable RRT and to calculate the version information of the variable RRT at the time of recording from the date of recording of the digital television program.

While the control portion 1 is formed to confirm the presence or absence of the program rating information of the digital television program to be reproduced and to confirm whether or not to reproduce the digital television program by recognizing whether or not the variable RRT is updated from that at the time of recording if the digital television program to be reproduced includes the program rating information in the aforementioned embodiment, the present invention is not restricted to this. The control portion may alternatively be formed to recognize whether or not the variable RRT is updated regardless of whether or not the digital television program to be reproduced includes the program rating information, to inform the user that the variable RRT is updated and confirm whether or not to reproduce the digital television program if the digital television program includes the program rating information, and to only inform the user that the variable RRT is updated if the digital television program does not include the program rating information, for example.

While the control portion 1 is formed to perform parental control of the digital television program with the RRTs (the variable RRT and the fixed RRTs) based on ATSC A/65C in the aforementioned embodiment, the present invention is not restricted to this. According to the present invention, the control portion 1 may alternatively be formed to perform parental control with rating tables other than the RRTs based on ATSC A/65C. Further alternatively, the control portion 1 may be formed to perform parental control with rating information other than the rating tables. The present invention is applicable to a case of performing parental control with updatable rating information.

While the display field 51 of the display 110 is formed to display the title of the recorded digital television program when the display 110 selectably displays the options (“OK” and “cancel”) (see FIG. 11) as to whether or not to reproduce the digital television program in the aforementioned embodiment, the present invention is not restricted to this. According to the present invention, the display field 51 may alternatively be formed to also display the date of recording of the digital television program, the name of the broadcast station and the like, in addition to the title of the recorded digital television program.

What is claimed is:

1. A digital broadcast recording/reproducing apparatus comprising:
a receiving portion receiving a digital television broadcast signal, supplied from a broadcast station, including rating information used as the criterion for parental control;
a recording storage portion reproducibly storing said digital television broadcast signal received by said receiving portion; and
a control portion recording a prescribed digital television program included in said digital television broadcast signal received by said receiving portion in said recording storage portion, reproducing recorded said digital television program and performing parental control of said digital television program on the basis of said rating information, wherein
said control portion is formed to recognize whether or not said rating information is updated from that at the time of recording of said digital television program when reproducing said digital television program recorded in said recording storage portion and to inquire of the user as to whether or not to perform parental control of said digital television program if said rating information is updated at the time of reproduction.

2. The digital broadcast recording/reproducing apparatus according to claim 1, wherein
said rating information includes program rating information indicating the rating every said digital television program and a rating table having a plurality of said program rating information,
the digital broadcast recording/reproducing apparatus further comprises a rating storage portion updatably storing said rating table, and
said control portion is formed to recognize whether or not said rating table is updated from that at the time of recording of said digital television program when reproducing said digital television program including said program rating information and to inquire of the user as to whether or not to perform parental control of said digital television program including said program rating information if said rating table is updated at the time of reproduction.

3. The digital broadcast recording/reproducing apparatus according to claim 2, wherein
said control portion is formed to recognize whether or not said rating table is updated by comparing information related to updating of said rating table at the time of recording of said digital television program with information related to updating of said rating table at the time of reproduction of said digital television program.

4. The digital broadcast recording/reproducing apparatus according to claim 2, wherein
said information related to updating of said rating table includes at least either version information of said rating table or information related to the date of updating of said rating table.

5. The digital broadcast recording/reproducing apparatus according to claim 4, wherein
said control portion is formed to recognize whether or not said rating table at the time of reproduction is updated by comparing version information of said rating table at the time of recording of said recorded digital television program with version information of said rating table at the time of reproduction.

6. The digital broadcast recording/reproducing apparatus according to claim 5, wherein
said control portion is formed to store at least said version information of said rating table at the time of recording when recording said digital television program.

7. The digital broadcast recording/reproducing apparatus according to claim 6, wherein
said control portion is formed to store said rating table at the time of recording including said version information when recording said digital television program.

8. The digital broadcast recording/reproducing apparatus according to claim 7, wherein
said control portion is formed to store said rating table at the time of recording including said version information in said recording storage portion along with said digital television program when recording said digital television program.

9. The digital broadcast recording/reproducing apparatus according to claim 2, wherein
said control portion is formed to inform the user that reproduced said digital television program includes said program rating information and to confirm whether or not to reproduce said digital television program if said rating table at the time of reproduction is updated from said rating table at the time of recording when reproducing said digital television program including said program rating information.

10. The digital broadcast recording/reproducing apparatus according to claim 9, wherein
said control portion is formed to inform the user that reproduced said digital television program includes said program rating information by displaying a message indicating that reproduced said digital television program includes said program rating information on a display.

11. The digital broadcast recording/reproducing apparatus according to claim 9, wherein
said control portion is formed to selectably display options as to whether or not to reproduce said digital television program on said display.

12. The digital broadcast recording/reproducing apparatus according to claim 11, wherein
said control portion is formed to display at least the title of recorded said digital television program on said display in addition to said options when selectably displaying said options as to whether or not to reproduce said digital television program on said display.

13. The digital broadcast recording/reproducing apparatus according to claim 2, wherein
said control portion is formed to make an inquiry as to whether or not to perform parental control at the time of reproduction of recorded said digital television program including said program rating information when said rating table is updated every time said control portion reproduces said recorded digital television program including said program rating information.

14. The digital broadcast recording/reproducing apparatus according to claim 2, wherein
said control portion is formed to recognize whether or not said digital television program includes said program rating information when reproducing said digital television program recorded in said recording storage portion.

15. The digital broadcast recording/reproducing apparatus according to claim 14, wherein
said control portion is formed to reproduce a digital television program not including said program rating information without recognizing whether or not said rating table is updated from that at the time of recording of said digital television program not including said program rating information if recorded said digital television program does not include said program rating information.

16. The digital broadcast recording/reproducing apparatus according to claim 2, wherein
said rating storage portion is enabled to store an updatable variable rating table and an unupdatable fixed rating table, and
said control portion is formed to determine on which one of said variable rating table and said fixed rating table said program rating information of reproduced said digital television program is based when reproduced said digital television program includes said program rating information.

17. The digital broadcast recording/reproducing apparatus according to claim 16, wherein
said control portion is formed to perform parental control based on said fixed rating table without recognizing whether or not said rating table is updated from that at the time of recording of said digital television program if said program rating information of said reproduced digital television program is based on said fixed rating table at the time of reproduction of said digital television program including said program rating information.

18. The digital broadcast recording/reproducing apparatus according to claim 2, wherein
said control portion is formed to perform parental control of said digital television program on the basis of said rating table without informing the user that reproduced said digital television program includes said program rating information if said rating table at the time of reproduction is not updated from said rating table at the time of recording when reproducing said digital television program including said program rating information.

19. The digital broadcast recording/reproducing apparatus according to claim 2, wherein
said rating table is an RRT (Rating Region Table) based on ATSC A/65C (Program and System Information Protocol) according to ATSC (Advanced Television Systems Committee).

20. A parental control method for a digital television program, comprising the steps of:
recognizing whether or not rating information used as the criterion for parental control is updated from that at the time of recording of a digital television program when reproducing recorded said digital television program; and
inquiring of the user as to whether or not to perform parental control of said digital television program if said rating information is updated from that at the time of recording of said digital television program at the time of reproduction.
